(19) United States
(12) Patent Application Publication
(10) Pub. No.: US 2012/0179586 A1
(43) Pub. Date: Jul. 12, 2012

(54) COMPUTER BASED SYSTEM FOR SPEND ANALYSIS SOLUTION THROUGH STRATEGIES FOR MINING SPEND INFORMATION

(76) Inventors: Bikash Mohanty, Mumbai (IN); Ashish Jha, Mumbai (IN)

(21) Appl. No.: 13/423,285

(22) Filed: Mar. 19, 2012

(30) Foreign Application Priority Data
Dec. 28, 2011 (IN) 3680/MUM/2011

(51) Int. Cl. G06Q 40/00

(52) U.S. Cl. 705/30

(57) ABSTRACT

A computer based system for spend analysis solution through strategies for mining spend information, the system comprises a processor unit; and a computer readable medium storing instructions executable by the processor unit comprising classification means adapted to classify spend data in accordance with pre-determined parameters of classification; categorization means adapted to categorize classified spend data based on pre-defined parameters; input means adapted to input pre-defined fields in relation to category of spend data, supplier information, payment terms, contracts or contract terms, and other pre-defined dimensions; saving strategy analysis engine adapted to analyze classified and categorized spend data based on pre-determined strategies, said saving strategy analysis engine further comprising category based saving strategy analysis engine adapted to output saving strategy per identified category inputs; and supplier based saving strategy analysis engine adapted to output saving strategy per identified supplier inputs.

### CROSS REFERENCES TO RELATED APPLICATIONS

The present invention claims priority to the Indian patent application No. 3680/MUM/2011, entitled “A Computer based System for Spend Analysis Solution through Strategies for Mining Spend Information”, filed Dec. 28, 2011, commonly assigned and herein incorporated by reference.

### FIELD OF THE INVENTION

This invention relates to the field of information and computation systems. In particular, this invention relates to the field of information and computation systems in relation to procurement performance. More particularly, this invention relates to spend analysis solution through strategies for mining spend information.

### BACKGROUND OF THE INVENTION

In all organizations, spend data is the data in relation to all spending activity in the organization. Spend data has direct correlation with organization turnover, profit percentage, and the like. Analysis of spend data is important to understand organizational needs, redundancies in spend data, and actionable points to curb redundancies.

Purchasing professionals are constantly looking for opportunity to save money. Most of the time the saving opportunity lies within their organization and can be identified from their spend data.

The major challenges in finding savings opportunity are as follows: Spend data are huge in volume, no standard strategy available across organization. U.S. patent application No. 20030139986 discloses a system and method for tracking spend analysis. Said tracking system method provides a correlation of spend items within the plurality of purchasing categories such as suppliers, types of goods, and/or business units received from a user. Further it identifies non-discretionary spend items thereby analyzing true spend within an organization.

U.S. patent application No. 20090100017 discloses a computer implemented method for processing spend data, the computer implemented method comprises responsive to capturing data feeds from one or more clients and a service provider, normalizing spend data contained within the data feeds by mapping the spend data to a common universal taxonomy using a business rule set to form normalized spend data; storing the normalized spend data within an aggregated spend database; running report queries against total aggregated spend data within the aggregated spend database; and posting results of the report queries on a secure web portal for viewing by authorized users.

A patent pending flexible spend tracking tool “GEP spend” from The GEP®/Global eProcure is AI based Spend Analysis Engine, easy to use cloud based tool help analyses and classify large volume of spend data. Further, it works with data from any system, in any file type in any language or character set by cleansing, validating and normalizing the data for complete analysis. Further it provides insight on where and how to achieve cost savings across entire spend.

### SUMMARY OF THE INVENTION

An object of the invention is to provide a system to classify spend data. Another object of the invention is to provide a system to analyze spend data. Yet another object of the invention is to provide a system which provides actionable opportunities' report based on classified and analysed spend data.

According to this invention, there is provided a computer based system for spend analysis solution through strategies for mining spend information, the system comprises: a processor unit; and a computer readable medium storing instructions executable by the processor unit comprising: classification means adapted to classify spend data in accordance with pre-determined parameters of classification; categorization means adapted to categorize classified spend data based on pre-defined parameters; input means adapted to input pre-defined fields in relation to category of spend data, supplier information, payment terms, contracts or contract terms, and other pre-defined dimensions; saving strategy analysis engine adapted to analyze classified and categorized spend data based on pre-determined strategies, said saving strategy analysis engine adapted to output saving strategy per identified inputs. Typically, said saving strategy engine comprising a supplier consolidation saving strategy formulating means adapted to output savings achieved due to reducing supplier base to top suppliers.

Typically, said saving strategy engine comprising a spend consolidation saving strategy formulating means adapted to output savings achieved due to aggregating demand from different business units.

Typically, said saving strategy engine comprising a contract compliance saving strategy formulating means adapted to output savings achieved by reducing spend from off-contract.

Typically, said saving strategy engine comprising a payment term rationalization strategy formulating means adapted to output savings achieved due to getting the best payment term from each supplier.

Typically, said saving strategy engine comprising a region spread strategy formulating means adapted to provide a region spread strategy and to output elaborates savings achieved due to dealing with global supplier

Typically, said saving strategy engine comprising a category spread strategy formulating means adapted to output elaborates savings achieved due to dealing with supplier who provide higher number of category.

Typically, said saving strategy engine comprising a payment term strategy formulating means adapted to output elaborate savings achieved by getting best payment term from suppliers.

Typically, said system includes a scope determination means adapted to determine scope of each of spend data and each of said strategy engines depending upon pre-determined parameters of spend data selection.

Typically, said system includes an unknown category addition means adapted to add categories in relation to spend data.

Typically, said system includes a known category addition means adapted to add categories in relation to spend data.

Typically, said system includes a constraint parameter addition means adapted to add constraints and defined values/threshold of each constraint parameter.

Typically, said system includes a query formulation means adapted to formulate queries on spend data depending upon defined constraints in order to provide results.

Typically, said system includes a report generation means adapted to generate reports of results in correlation with defined constraints and strategies in order to have access and visibility of the saving opportunity strategies.

According to this invention, there is also provided a computer based method for spend analysis solution through strategies for mining spend information, the method comprises the steps of: classifying spend data in accordance with pre-determined parameters of classification; categorizing classified spend data based on pre-defined parameters; input means adapted to input pre-defined fields in relation to category of spend data, supplier information, payment terms, contracts or contract terms, and other pre-defined dimensions; analyzing classified and categorized spend data based on pre-determined strategies, said analyzing method comprising the steps of outputting saving strategy per identified category inputs; and outputting saving strategy per identified supplier inputs.

Typically, said step of analyzing includes the step of outputting savings achieved due to reducing supplier base to top suppliers.

Typically, said step of analyzing includes the step of outputting savings achieved due to aggregating demand from different business units.

Typically, said step of analyzing includes the step of outputting savings achieved by reducing spend from off-contract.

Typically, said step of analyzing includes the step of outputting savings achieved due to getting the best payment term from each supplier.

Typically, said step of analyzing includes the step of outputting region spread strategy and to output elaborates savings achieved due to dealing with global supplier

Typically, said step of analyzing includes the step of outputting savings achieved due to dealing with supplier who provide higher number of category.

Typically, said step of analyzing includes the step of outputting savings achieved by getting best payment term from suppliers.

Typically, said method includes the step of determining scope of each of spend data and each of said strategy engines depending upon pre-determined parameters of classification.

Typically, said method includes the step of adding categories in relation to spend data.

Typically, said method includes the step of adding categories in relation to spend data.

Typically, said method includes the step of adding constraints and defined values/threshold of each constraint parameter.

Typically, said method includes the step of formulating queries on spend data depending upon defined constraints in order to provide results.

Typically, said method includes the step of generating reports of results in correlation with defined constraints and strategies in order to have access and visibility of the saving opportunity strategies.

### BRIEF DESCRIPTION OF THE ACCOMPANYING DRAWINGS

Embodiments of the present invention are illustrated in the figures of the accompanying drawings. The figures are provided to aid thorough understanding of the invention and are exemplary rather than limiting. Based on the present teachings, person of ordinary skill in the art can contemplate various alternatives, variations and modifications to the illustrated embodiments within the scope of the invention disclosed herein.

The invention will now be described in relation to the accompanying drawings, in which:

FIG. 1 illustrates schematic Manual savings identification process;

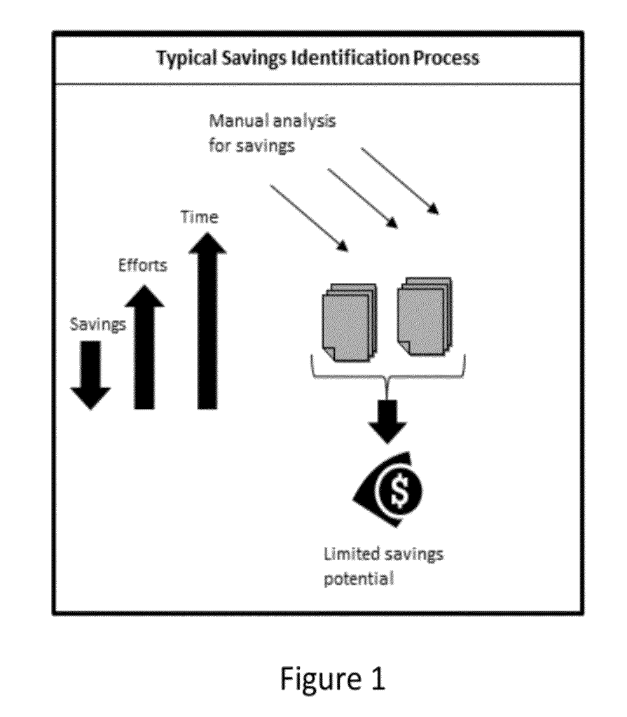

FIG. 2 illustrates schematic Savings identification with iMine;

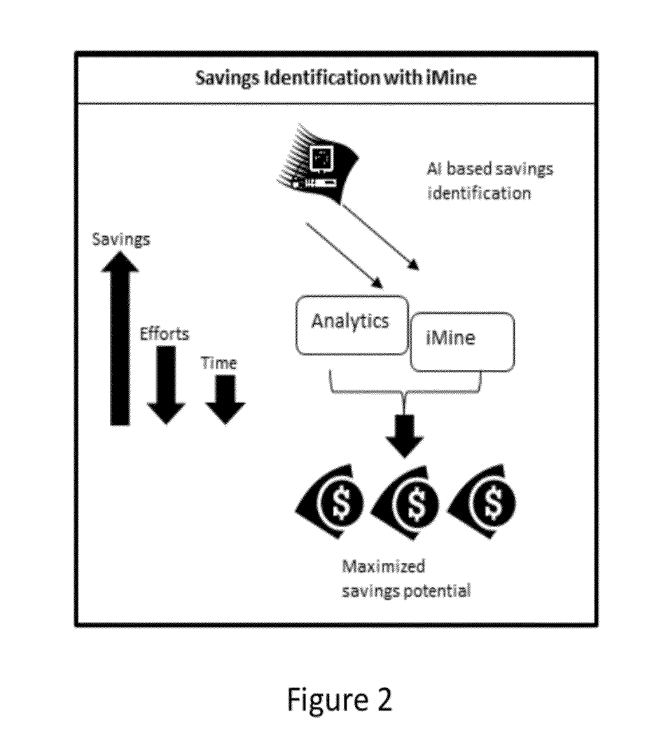

FIG. 3 illustrates iMine home: Pre-Packaged strategy;

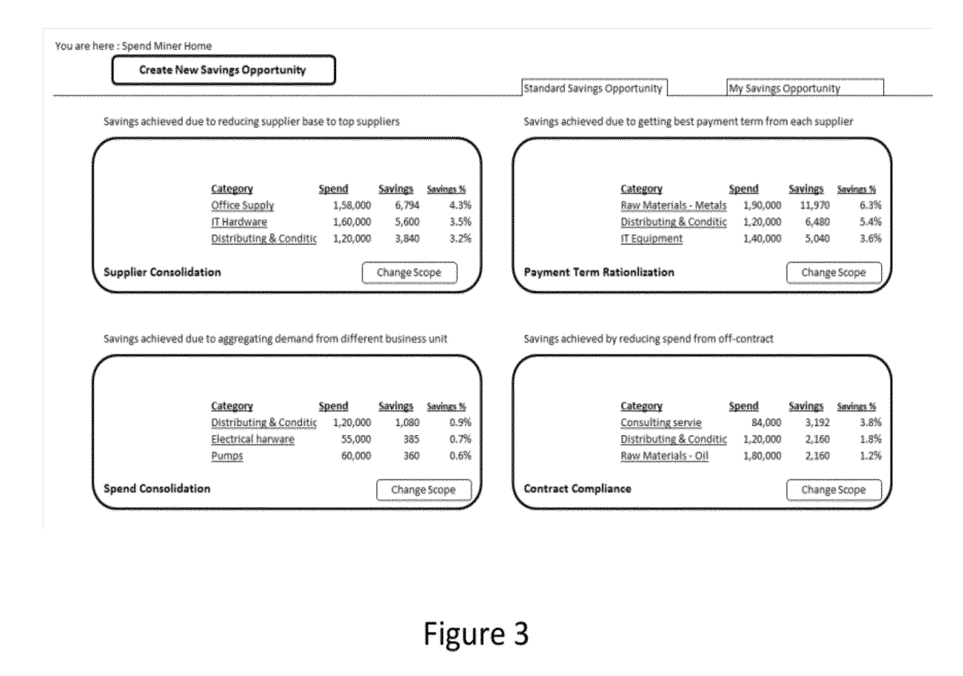

FIG. 4 illustrates exemplary computer screenshots for addressable spend for unknown category;

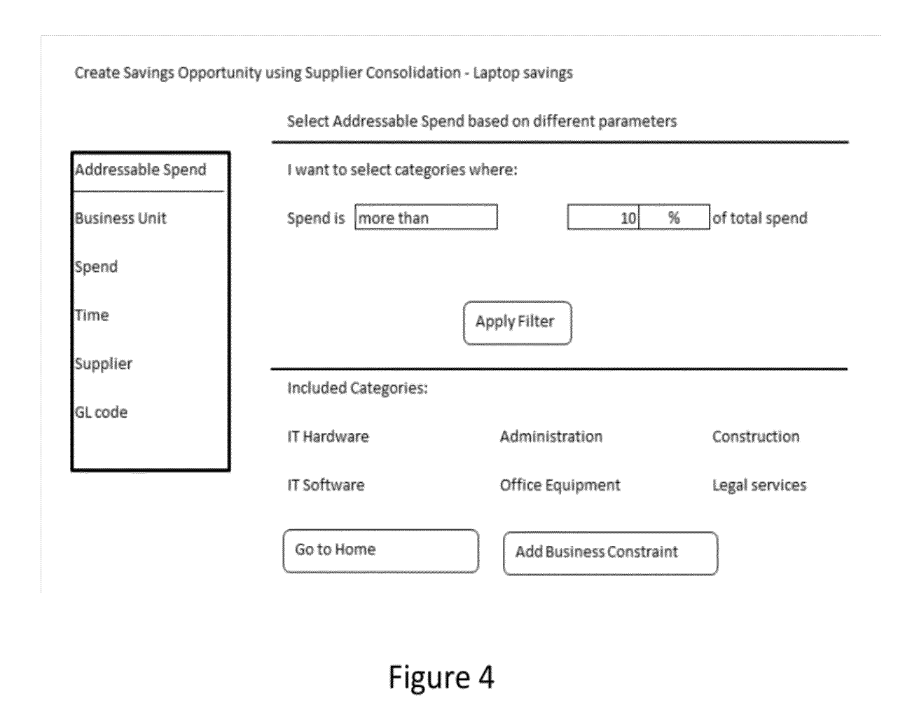

FIG. 5 illustrates exemplary computer screenshots for addressable spend—for known category;

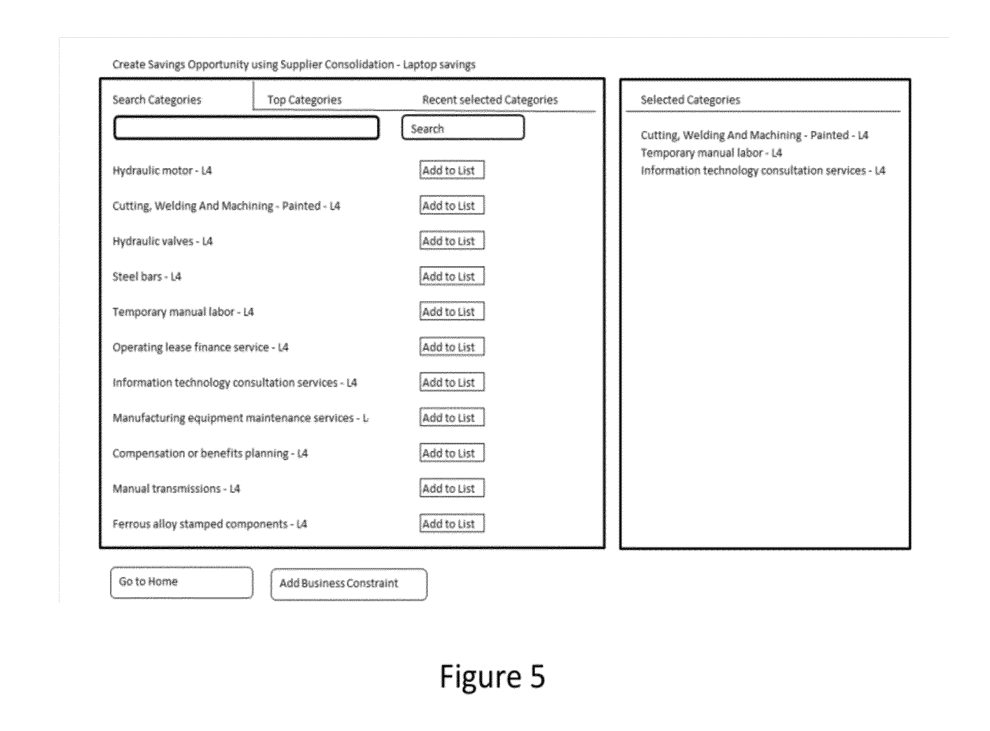

FIG. 6 illustrates exemplary computer screenshots to define business constraint;

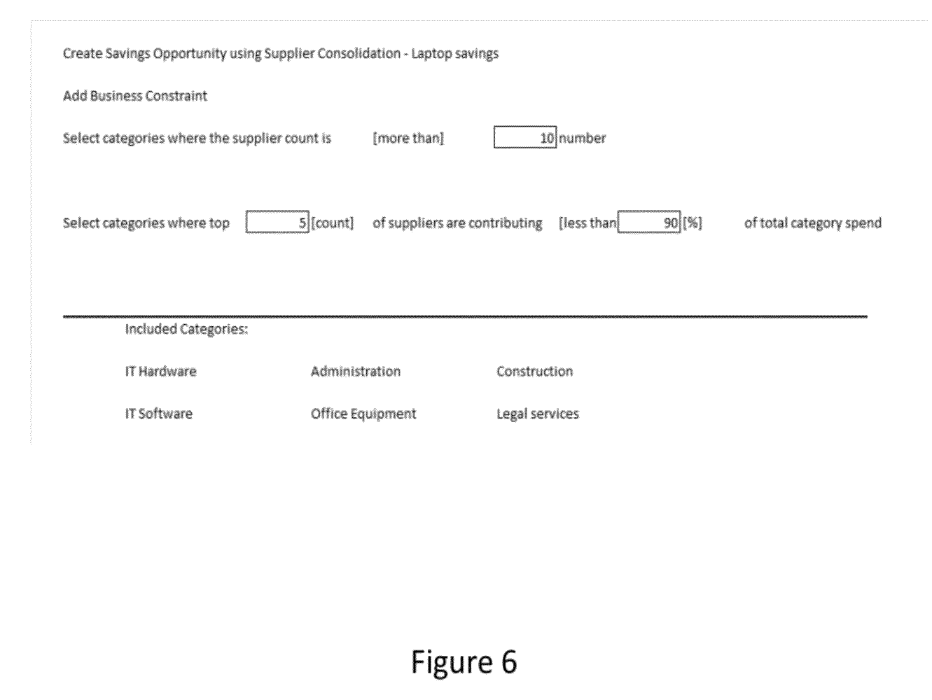

FIG. 7 illustrates the listing of saving opportunity created and scheduled; and

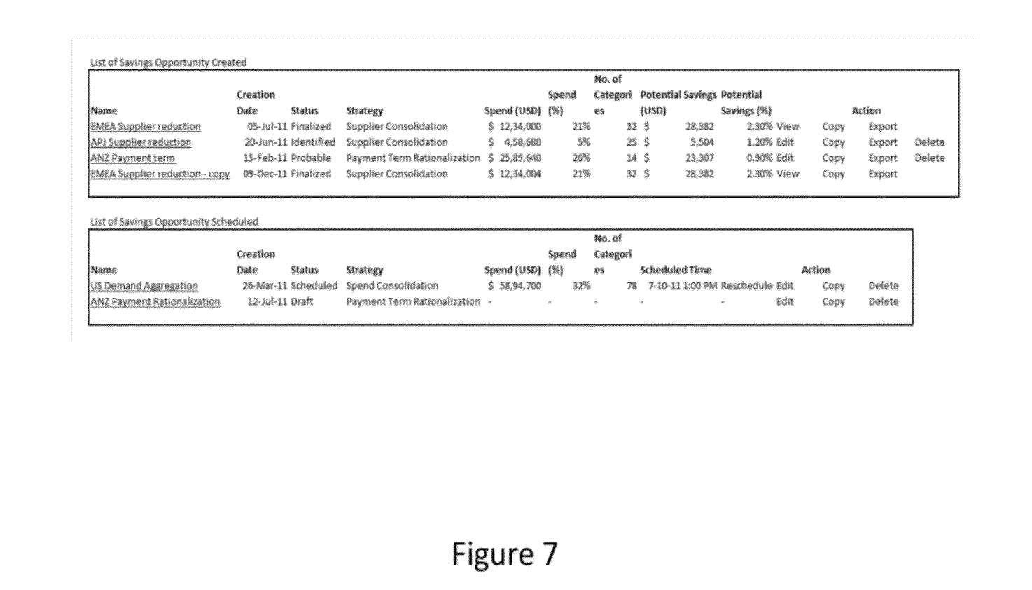

FIG. 8 illustrates the report for savings opportunity.

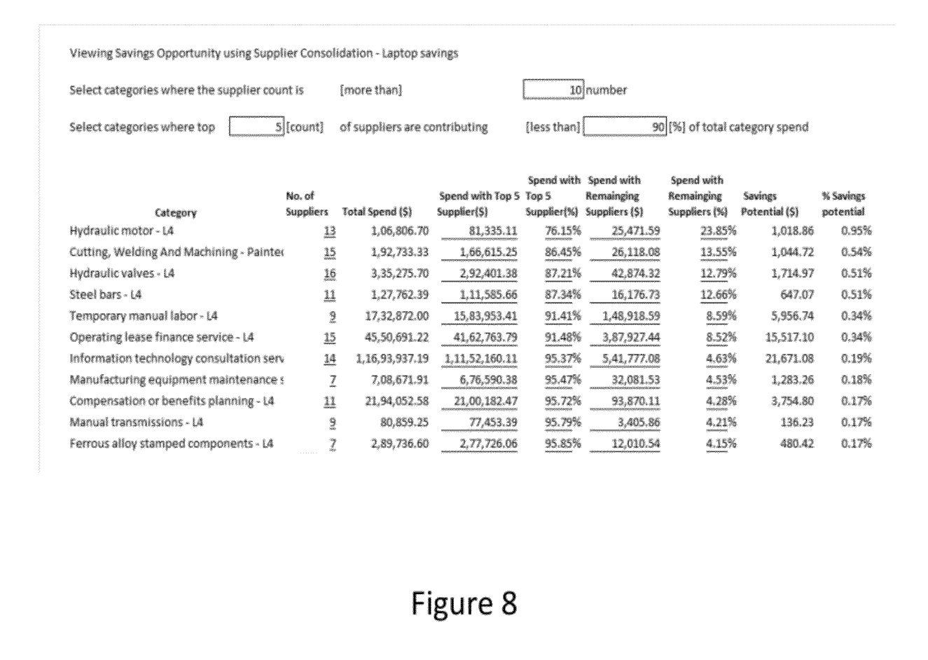

### DETAILED DESCRIPTION OF THE INVENTION

The specific embodiments of the present invention are described below in greater detail. The following description of the specific embodiments refers at various places to the accompanying drawings and specific environments, applications, platforms, examples, computer screenshots, and implementations. Such description is provided for thorough understanding of the present invention and is illustrative rather than limiting.

According to this invention, there is provided a system and method for spend analysis solution through strategies for mining spend information.

The system and method of this invention aims to offer strategies for mining spend information. The key features of the system and method of this invention are as follows: Built-in, standard category and supplier based savings strategies, easy creation of business constraints for data analysis, create addressable spend definitions based on multiple parameters.

The major benefits being offered are as follows: Start with actionable opportunities not just static spend reports, simplify the process of creating opportunity reports, isolate and analyze datasets with high savings potential.

In accordance with an embodiment of this invention, there is provided a classification means adapted to classify spend data in accordance with pre-determined parameters of classification. The system and method of this invention works on classified spend data.

In accordance with another embodiment of this invention, there is provided a categorization means adapted to categorize classified spend data based on pre-defined parameters.

In accordance with another embodiment of this invention, there is provided an input means adapted to input pre-defined fields in relation to category of spend data, supplier information, payment terms, contracts or contract terms, and other pre-defined dimensions. The category includes category names and category classification. Suppliers include normalized vendors. Other dimensions include Region, Time, General Ledger, Business Units, Data Source, and the like.

In accordance with another embodiment of this invention, there is provided a saving strategy analysis engine adapted to analyze classified and categorized spend data based on pre-determined strategies. The saving strategy analysis engine comprises the following engines: Category based saving strategy analysis engine to output saving strategy per identified category, supplier based saving strategy analysis engine to output saving strategy per identified supplier.

Purchasing professionals would investigate spend data based on different strategies to find out saving opportunity. Depending on organizational structure and business processes these strategies could be based on category, supplier, business unit, region, or the like pre-defined parameters.

In accordance with another embodiment of this invention, there is provided a category based saving strategy engine adapted to provide saving strategies in relation to category inputs.

In accordance with another embodiment of the category based saving strategy engine of this invention, there is provided a supplier consolidation saving strategy formulating means. This output elaborates savings achieved due to reducing supplier base to top suppliers. Consolidation of suppliers means reducing the number of suppliers that the organization deals with, for example by introducing a corporate contract with one supplier in place of contracts with several suppliers made by individual departments. The Action/Impact points include: Leverage spend with suppliers, price negotiation lever, optimization of procurement practices, improves visibility across plants, also depicts estimated saving statistics which can be achieved by implementing the saving strategy in reality terms.

In accordance with another embodiment of the category based saving strategy engine of this invention, there is provided a spend consolidation saving strategy formulating means. This output elaborates savings achieved due to aggregating demand from different business units. Consolidation of spend means bringing together the expenditure on particular goods and services incurred by individual departments of the organization, so that contracts can be created to cover the total expenditure for the goods and services. The Action/Impact points include: Volume discounts and price negotiation, rationalization of demand, improves compliance, reduces over head costs.

In accordance with another embodiment of the category based saving strategy engine of this invention, there is provided a contract compliance saving strategy formulating means. This output elaborates savings achieved by reducing spend from off-contract. Contract Compliance would ensure savings by tracking spend through contract. The Action/Impact points include: Monitoring of contract leakages, improved process compliance across the organization, increased contract visibility.

In accordance with another embodiment of the category based saving strategy engine of this invention, there is provided a payment term rationalization strategy formulating means. This output elaborates savings achieved due to getting the best payment term from each supplier. Payment term rationalization means negotiating better payment terms with suppliers who are giving different payment terms. Savings could be realized in terms of increased accounts payable cash flow. The Action/Impact points include: Optimize procurement practices, Negotiation leverage.

In accordance with another embodiment of this invention, there is provided a supplier based saving strategy engine adapted to provide saving strategies in relation to supplier inputs.

In accordance with another embodiment of the supplier based saving strategy engine of this invention, there is provided a region spread strategy formulating means adapted to provide a region spread strategy. This output elaborates savings achieved due to dealing with global supplier

In accordance with another embodiment of the supplier based saving strategy engine of this invention, there is provided a category spread strategy formulating means adapted to provide a category spread strategy. This output elaborates savings achieved due to dealing with supplier who provide higher number of category.

In accordance with another embodiment of the supplier based saving strategy engine of this invention, there is provided a payment term strategy formulating means adapted to provide a payment rationalization strategy. This output elaborates savings achieved by getting best payment term from suppliers.

In accordance with an embodiment of this invention, there is provided a scope determination means adapted to determine scope of each of spend data and each of said strategy engines depending upon pre-determined parameters of classification. There is an addressable spend parameter which is input and used by the scope determination means.

When a purchasing professional (Let's say, Category Manager as a user) starts looking for savings opportunity, he/she would first decide the scope of analysis for mining spend data. One of the reasons could be that he/she is responsible for specific category or region. These become the actionable addressable spend for the respective users.

In accordance with another embodiment of this invention, there is provided an unknown category addition means adapted to add categories in relation to spend data. The system and method of this invention provides capability to find out addressable spend by using different parameters.

For a category manager, the parameters could be region, geography, spend range, time period, General Ledger (GL), and the like. Using combination of these parameters users can find the addressable spend. These parameters would be configurable as per pre-defined dimensions.

In accordance with another embodiment of this invention, there is provided a known category addition means adapted to add categories in relation to spend data. If the user knows the spend category, he/she can directly select those as addressable spend. User can search for their category using free text and the system would suggest the relevant category names. User can also search from top category or recent searches. The user would then add selected categories as their addressable spend.

In accordance with another embodiment of this invention, there is provided a constraint parameter addition means adapted to add constraints and defined values/threshold of each constraint parameter. User would mine the spend data using different strategies on these addressable spend. The strategies could be changed by user based on their requirement. The system and method of this invention provides easy to use options to add business constraints using simple text definition.

According to a non-limiting exemplary embodiment, the business constraint for different strategies based on category would be as follows:

1) Supplier Consolidation Strategy—To reduce the number of suppliers, user need to find out those categories where top few suppliers are providing less than optimum spend.

a) Select categories where the supplier count is [more than/less than] [x] number.
b) Select categories where top [y] [count] of suppliers are contributing [less than/more than] [z] % of total category spend.

2) Spend Consolidation—To consolidate spend across organization, user need to find out those categories which are procured in multiple business units.

a) Select categories which is procured in [more than/less than] [x] count of business units.
b) Select categories where [less than/more than] [y] % of spend is spread across top [z] count of suppliers.

3) Contract Compliance—To ensure contract compliance, user need to find out those categories where spend from outside contract is high.

a) Select categories where [more than/less than] [x] % of spend is outside contract.

4) Payment Term Strategy—To get the best payment term from suppliers, user need to find out those categories where supplier is asking for different payment term.

Select categories where payment term is different coming from same supplier.

The above text is present in the application for respective strategy. User needs to select and enter only that information which is shown in parenthesis [ ]. Once the user defines the business constraint, he/she can schedule to run the report at given time.

In accordance with another embodiment of this invention, there is provided a query formulation means adapted to formulate queries on sped data depending upon defined constraints in order to provide results.

Once the user defines the business constraint, it is used as query for backend processing. This query is fired on the spend data set for the customer. The relevant result is made available depending upon the business constraint defined by the user.

It is possible that there is no result found as a result of the query fired on the spend cube. This may be due to the reason that the business constraint which the user has fired is not resulting in any result.

In accordance with another embodiment of this invention, there is provided a report generation means adapted to generate reports of results in correlation with defined constraints and strategies. Reports for the business constraint applied are available. These reports present the required information which would help the user to take action based on the strategy that the user has selected. Reports are available in both tabular and graphical format. The information detail is as per the strategy selected.

The report presents savings number based on assumptions. These assumptions are based on applicant's experience on spend analysis and analyst findings. User can change the assumption using What-If analysis.

The report has a list of categories which have matched the business constraint. User can edit the report in probable status to manually select categories and move it to identified status. Once the user is satisfied with the selection, she can mark the saving opportunity as finalized.

In an embodiment, the present invention provides a computer based method for spend analysis solution through strategies for mining spend information, the method comprising the steps of: classifying spend data in accordance with pre-determined parameters of classification; categorizing classified spend data based on pre-defined parameters; inputting pre-defined fields in relation to category of spend data, supplier information, payment terms, contracts or contract terms, and other pre-defined dimensions; and analyzing classified and categorized spend data based on pre-determined strategies, said analyzing method comprising the steps of outputting saving strategy per identified inputs. In the method, said step of analyzing includes the step of outputting savings achieved due to dealing with supplier who provide higher number of category. In the method, said step of analyzing includes the step of outputting savings achieved by getting best payment term from suppliers. The method includes the step of determining scope of each of spend data and each of said strategy engines depending upon pre-determined parameters of classification. The method includes the step of adding categories in relation to spend data. The method includes the step of adding categories in relation to spend data. The method includes the step of adding constraints and defined values/threshold of each constraint parameter. The method includes the step of formulating queries on spend data depending upon defined constraints in order to provide results. The method includes the step of generating reports of results in correlation with defined constraints and strategies in order to have access and visibility of the saving opportunity strategies.

While this detailed description has disclosed certain specific embodiments of the present invention for illustrative purposes, various modifications will be apparent to those skilled in the art which do not constitute departures from the spirit and scope of the invention as defined in the following claims, and it is to be distinctly understood that the foregoing descriptive matter is to be interpreted merely as illustrative of the invention and not as a limitation.

What is claimed is:

1. A computer based system for spend analysis solution through strategies for mining spend information, the system comprising:
a processor unit; and
a computer readable medium storing instructions executable by the processor unit comprising:
classification means adapted to classify spend data in accordance with pre-determined parameters of classification;
categorization means adapted to categorize classified spend data based on pre-defined parameters;
input means adapted to input pre-defined fields in relation to category of spend data, supplier information, payment terms, contracts or contract terms, and other pre-defined dimensions; and
saving strategy analysis engine adapted to analyze classified and categorized spend data based on pre-determined strategies, said saving strategy analysis engine adapted to output saving strategy per identified inputs.

2. The system as claimed in claim 1 wherein, said saving strategy engine comprising a supplier consolidation saving strategy formulating means adapted to output savings achieved due to reducing supplier base to top suppliers.

3. The system as claimed in claim 1 wherein, said saving strategy engine comprising a spend consolidation saving strategy formulating means adapted to output savings achieved due to aggregating demand from different business units.

4. The system as claimed in claim 1 wherein, said saving strategy engine comprising a contract compliance saving strategy formulating means adapted to output savings achieved by reducing spend from off-contract.

5. The system as claimed in claim 1 wherein, said saving strategy engine comprising a payment term rationalization strategy formulating means adapted to output savings achieved due to getting the best payment term from each supplier.

6. The system as claimed in claim 1 wherein, said saving strategy engine comprising a region spread strategy formulating means adapted to provide a region spread strategy and to output elaborates savings achieved due to dealing with global supplier.

7. The system as claimed in claim 1 wherein, said saving strategy engine comprising a category spread strategy formulating means adapted to provide a category spread strategy and to output elaborates savings achieved due to dealing with supplier who provide higher number of category.

8. The system as claimed in claim 1 wherein, said saving strategy engine comprising a payment term strategy formulating means adapted to provide a payment rationalization strategy and to output elaborate savings achieved by getting best payment term from suppliers.

9. The system as claimed in claim 1 wherein, said system includes a scope determination means adapted to determine scope of each of spend data and each of said strategy engines depending upon pre-determined parameters of classification.

10. The system as claimed in claim 1 wherein, said system includes an unknown category addition means adapted to add categories in relation to spend data.

11. The system as claimed in claim 1 wherein, said system includes a known category addition means adapted to add categories in relation to spend data.

12. The system as claimed in claim 1 wherein, said system includes a constraint parameter addition means adapted to add constraints and defined values/threshold of each constraint parameter.

13. The system as claimed in claim 1 wherein, said system includes a query formulation means adapted to formulate queries on spend data depending upon defined constraints in order to provide results.

14. The system as claimed in claim 1 wherein, said system includes a report generation means adapted to generate reports of results in correlation with defined constraints and strategies in order to have access and visibility of the saving opportunity strategies.

15. A computer based method for spend analysis solution through strategies for mining spend information, the method comprising the steps of:
classifying spend data in accordance with pre-determined parameters of classification;
categorizing classified spend data based on pre-defined parameters;
input means adapted to input pre-defined fields in relation to category of spend data, supplier information, payment terms, contracts or contract terms, and other pre-defined dimensions; and
analyzing classified and categorized spend data based on pre-determined strategies, said analyzing method comprising the steps of outputting saving strategy per identified inputs.

16. The method as claimed in claim 1 wherein, said step of analyzing includes the step of outputting savings achieved due to reducing supplier base to top suppliers.

17. The method as claimed in claim 1 wherein, said step of analyzing includes the step of outputting savings achieved due to aggregating demand from different business units.

18. The method as claimed in claim 1 wherein, said step of analyzing includes the step of outputting savings achieved by reducing spend from off-contract.

19. The method as claimed in claim 1 wherein, said step of analyzing includes the step of outputting savings achieved due to getting the best payment term from each supplier.

20. The method as claimed in claim 1 wherein, said step of analyzing includes the step of outputting region spread strategy and to output elaborates savings achieved due to dealing with global supplier.
